(19) United States
(12) Patent Application Publication
(10) Pub. No.: US 2017/0178092 A1
(43) Pub. Date: Jun. 22, 2017

(54) REMITTANCE SYSTEM AND METHOD

(71) Applicant: EINNOVATIONS HOLDINGS PTE. LTD., Singapore (SG)

(72) Inventors: Oliver L. UBALDE, Makati City (PH); Richard C. SALCEDO, Makati City (PH); Evelyn M. BASAS, Makati City (PH); Jose Antonio C. YULO, Makati City (PH); Orlando B. VEA, Makati City (PH); Angelito M. VILLANUEVA, Mandaluyong City (PH); Agustin L. SANTIAGO, Mandaluyong City (PH)

(73) Assignee: EINNOVATIONS HOLDINGS PTE. LTD., Singapore (SG)

(21) Appl. No.: 15/115,740

(22) PCT Filed: Feb. 11, 2015
(86) PCT No.: PCT/SG2015/050020

§ 371 Date: Aug. 1, 2016

(30) Foreign Application Priority Data
Feb. 11, 2014 (SG) 2014011779
Apr. 28, 2014 (SG) 10201401866W

(51) Int. Cl. G06Q 20/10; G06Q 20/40; G06Q 20/16; G06Q 10/10; G06Q 50/00; G06Q 20/32; G06Q 20/36

(52) U.S. Cl. CPC G06Q 20/10; G06Q 20/3221; G06Q 20/405; G06Q 20/36; G06Q 10/107; G06Q 50/01; G06Q 20/16; G06Q 20/1085

(57) ABSTRACT

A remittance system comprising a remittance platform operable to process a remittance request originating from a sender to a target beneficiary; the remittance request comprising a primary account number (PAN) of the sender; the remittance platform further operable to create an electronic account for the target beneficiary upon determining that the target beneficiary does not have an approved PAN for remittance to take place; wherein the creation of the electronic account comprises a link between a unique identifier of the target beneficiary and the generation of a primary account number for the beneficiary.

### FIELD OF THE INVENTION

The present invention relates to a remittance system and method. The system and method are particularly relevant, but not limited to facilitating the remittance of monies remotely and will be described in such a context.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Current remittance service providers include banks, remittance agents, ATM, and telecommunications carrier, amongst others. However, in order to utilize such remittance service, the sender and beneficiary both have to subscribe to a particular service provider and each have to have a Primary Account Number (PAN) with the remittance service provider. The PAN is a unique identifier. For example, on a credit/debit card, the PAN is the sixteen (16) alpha-numeric card number. The bank card number merely identifies the card, which is then electronically associated by the issuing organisation with one of its customers and then to the customer's designated bank accounts.

The remittance service providers typically charge a fee for the use of their remittance service.

The above arrangement however is restrictive in the sense that it restricts a relatively sizable number of overseas workers, such as Overseas Filipino Workers (OFWs) who may not have a PAN number or may be restricted from having one due to inability to meet certain criteria such as minimum income, residency requirements etc.

Within the existing remittance structure, should a sender wish to remit to a beneficiary having an account with a different service provider, either the sender or beneficiary will have to open another account so that there is a ‘matching’ of service providers for the remittance to take place.

As an example, for any remittance services using network operators, such as telecommunications service providers, the sender has to have an electronic wallet account only as the fund source (of sender) while the target beneficiary mobile number must have a pre-linked PAN linked to an account of the telecommunications network.

The present invention seeks to improve on the existing remittance systems and methods to cater to overseas workers and in addition reduces or prevents the occurrence of transaction fraud to at least some extent while allowing greater flexibility for the senders and beneficiaries to send/receive the remittance without the need for ‘account matching’.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

The invention is developed to address the challenges of remittance transaction by knowing/memorizing the exact account number of PAN of beneficiary or target account.

The invention seeks to address the un-bank beneficiary customer through a remittance partner and fulfilment/encashment centre for the sending & receiving of remittance transaction and option to en-cash the remittance amount to beneficiary.

Another aspect of the invention seeks to avoid the risk of exposing the beneficiary confidential account number or PAN, which, once exposed, may be susceptible to possible fraud or scheming

Another aspect of the invention seeks to provide easy way of remittance transaction from sender to using the beneficiary's Mobile number.

Enhancement on this pending patent is to open to any source PAN (MasterCard, Visa, Bank CASA, etc.) or credit card while the destination MIN can be any pre-linked PAN or provide default auto-enrol from participating receiving bank virtual PAN inventory for auto-link to beneficiary's mobile number.

The enhancement of auto enrol feature is no longer limited to the existing Smart Money Account only and is applicable if the Mobile number has no available PAN (pre-linked account) where the remittance platform will execute auto-enrol by dispensing the virtual PAN that is available in database inventory to link as default PAN to mobile number.

Another enhancement is the sender will receive the notification via SMS if mobile number is available or via email of the email number is available in the transaction request. Compared the prior, the sender PAN always assumed linked to mobile number as mandatory field.

The beneficiary will receive SMS notification with reference number indicates the amount transferred from Sender PAN (mask form) to beneficiary mobile number. If the PAN is virtual due to auto-enrol then the beneficiary will also advice (thru SMS) to visit nearest Fulfilment/Encashment Centre or Receiving bank branch to encash their money using the reference number and/or apply to personalized their virtual PAN

This pending patent also introduce the easy and secured way to encash the remittance transaction at the Fulfilment/Encashment Centre using the reference number and a one-time token ID.

Another advantage associated with the invention is the flexibility of remittance transaction by eliminating the limitation of Smart Money as default source and target PAN linked to mobile number.

The invention also seeks to address the limitation of bank presence in the remote areas where the license/authorized remittance partner agent and/or fulfillment/encashment centre are present to provide service to sender and beneficiary for accepting sending & receiving of remittance transaction and option to encash the remittance amount to beneficiary.

In accordance with an aspect of the invention there is provided a remittance system and method comprising a remittance platform operable to receive, validate and process a request for remittance sent be a sender to a target beneficiary; the remittance platform further operable to create a virtual account for the beneficiary upon discovering that the target beneficiary is not an account holder of the remittance system; the virtual account further comprising a link between a personal identifier of the virtual account and a generated primary account number.

In accordance with a first aspect of the invention there is a remittance system comprising a remittance platform operable to process a remittance request originating from a sender to a target beneficiary; the remittance request comprising a primary account number (PAN) of the sender; the remittance platform further operable to create an electronic account for the target beneficiary upon determining that the target beneficiary does not have an approved PAN for remittance to take place; wherein the creation of the electronic account comprises a link between a unique identifier of the target beneficiary and the generation of a primary account number for the beneficiary.

Preferably, the unique identifier is a mobile identification number of the beneficiary.

Preferably, the PAN of the sender is linked to a fund source.

Preferably, the fund source is a bank, a credit card company, or other financial institutions.

Preferably, the beneficiary PAN is generated to match the fund source of the sender.

Preferably, the electronic account comprises an electronic wallet.

Preferably, the electronic wallet is linked to a plurality of identifiers of the sender or beneficiary.

Preferably, the plurality of identifiers include email address; social network accounts; and mobile identification number.

Preferably, the remittance platform is in data communication with a customer profile database.

Preferably, if the sender is not linked to a fund source, the primary account number of the sender is provided by an authorized remittance agent.

In accordance with a second aspect of the invention there is a method of remittance from a sender to a target beneficiary comprising receiving a remittance request originating from the sender; the remittance request comprising a primary account number (PAN) of the sender; determining whether the target beneficiary has a approved PAN for remittance to take place; and creating an electronic account for the target beneficiary if there is no approved PAN; wherein the creation of the electronic account comprises a link between a unique identifier of the target beneficiary and the generation of a primary account number for the beneficiary.

Preferably, the unique identifier is a mobile identifier of the target beneficiary.

Preferably, the PAN of the sender is linked to a fund source.

Preferably, the fund source is a bank, a credit card company, or other financial institutions.

Preferably, the beneficiary PAN is generated to match the fund source of the sender.

Preferably, the electronic account comprises an electronic wallet.

Preferably, the electronic wallet is linked to a plurality of identifiers of the sender or beneficiary.

Preferably, the plurality of identifiers includes email address; social network accounts; and mobile identification number.

Preferably, if the sender is not linked to a fund source, the primary account number of the sender is provided by an authorized remittance agent.

### BRIEF DESCRIPTION OF THE DRAWINGS

The present invention will now be described, by way of example only, with reference to the accompanying drawings, in which:

FIG. 1 illustrates a scenario where a sender through a sender bank (via over-the counter or portal channel) remits monies to a beneficiary where the beneficiary mobile identification number is linked with a primary account number (PAN) in accordance with an embodiment of the invention;

FIG. 2 illustrates a scenario where a sender through a sender bank (via over-the counter or portal channel) remits monies to a beneficiary where the beneficiary mobile identification number is not linked with a primary account number (PAN) in accordance with another embodiment of the invention;

FIG. 3 illustrates an unbanked scenario of remittance transaction through remittance via a partner agent where the Sender is unbanked and send cash remittance transaction to beneficiary's mobile identification number (MIN) in accordance with another embodiment of the invention;

FIG. 4 is a flow chart illustrating the overview process of remitting monies in accordance with another embodiment of the invention;

FIG. 5 is a flow chart illustrating the remittance transaction and the assumptions involved;

FIG. 6 is a flow chart illustrating the crediting process to an existing funding account and the assumptions involved;

FIG. 7 is a flow chart illustrating the application of a funding account to receive any remittance; and

FIG. 8 is a flow chart illustrating the withdrawal of remittance received.

Other arrangements of the invention are possible and, consequently, the accompanying drawings are not to be understood as superseding the generality of the description of the invention.

### DESCRIPTION OF EMBODIMENTS OF THE INVENTION

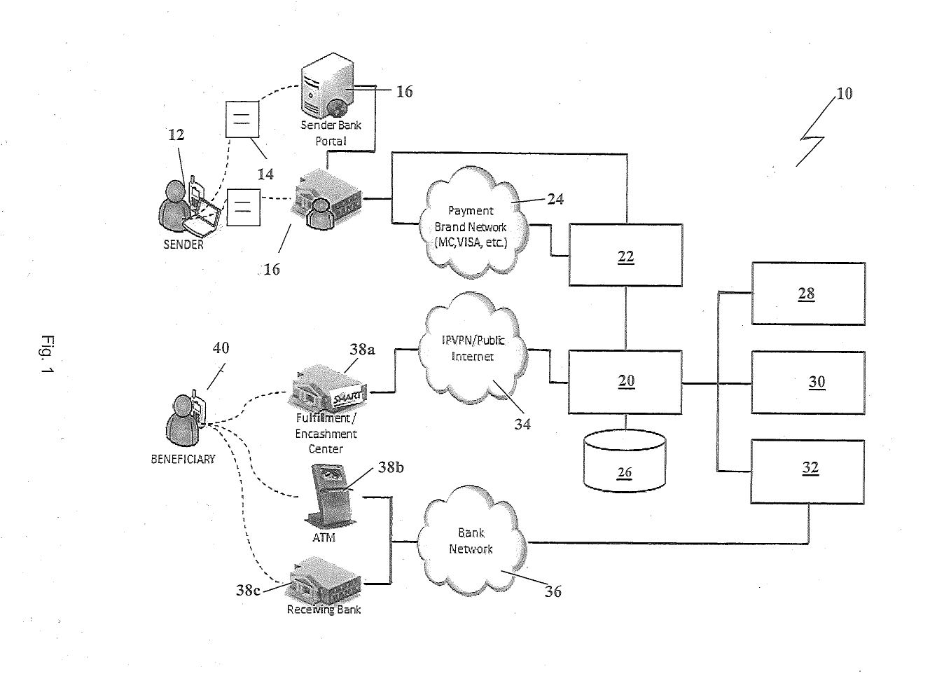

In accordance with an embodiment of the invention and with reference to FIG. 1 there is a remittance system 10 comprising a sender (inclusive of sender device) 12 operable to send a remittance request 14 via a bank portal or physical bank 16. Remittance system 10 comprises a remittance platform 20 operable to receive, validate and process remittance request 14 originating from the sender 12. Remittance system 10 may be hosted within a telecommunications network provider. The sender device 12 may be a mobile phone or smartphone having a mobile identification number or MSISDN. The sender may compose his remittance request 14 using SMS, USSD, etc. Sender device 12 may be installed with the necessary user interface for assisting the sender 12 to compose the remittance request 14.

Sender 12 has a virtual or electronic card account (credit card/debit card) with the bank 16. The electronic card account is associated with his primary account number PAN issued by the card issuers in accordance with established standards such as the sixteen digit ISO/IEC 7812. Such an account enables the sender 12 to remit monies to a beneficiary 40.

The card issuer such as, but not limited to Mastercard™ provides an acquiring gateway 22 to facilitate ‘card not present’ transactions. Acquiring Gateway 22 ensures that remittance request 14 is sent under a secured environment. Upon receiving a remittance request 14 either via the bank portal or physical bank 16, the remittance request 14 is sent through a payment network 24 which may be provided by the card issuer and/or the bank. Acquiring Gateway 22 provides the integration between Sender Bank 16 and remittance platform 20 to accept remittance requests 14 from a variety of providers such as Mastercard®, VISA® and other Payment brands. This acquiring gateway can be substituted or provided by payment brand like MIGS (MasterCard Internet Gateway Service) for Mastercard® or can be substituted or provided by any Acquiring Bank.

Remittance platform 20 is operable to be in data communication with a customer database 26. Customer database 26 comprises the profile of customers having accounts with the remittance system 10. Customer database 26 is further operable to store the linking of sender/beneficiary PAN & MIN and other related customer information for KYC (know your customer) rule, with regulatory implementations such as the required PCI-DSS (Payment Card Industry-Data Security Standard) & AMLA (anti-money laundering) compliance. This can be substituted by participating receiving bank customer database depending of agreed commercial and technical integration.

The remittance platform 20 is further operable to be in data communication with a plurality of beneficiary remittance channels. These channels include email server 28, SMS centre 30, card host system 32 of the beneficiary's financial institution (such as a bank), and the IPVPN/public Internet 34 for the sending of notifications and/or completion of the remittance process. Terminals 38 such as encashment centre 38a, ATMs 38b, receiving bank over-the-counter 38c etc. are provided for the withdrawal or encashment of the remittance sum of monies. The encashment feature provides the Fulfillment/Encashment Centre 38a office to provide encashment facility based on the reference number of remittance transaction

Remittance platform 20 is further operable to supply virtual PAN with an ‘auto-enrol’ process for mobile number (MIN) with no PAN. This can be any virtual PAN from participating banks as default Issuer and Receiving Bank that is covered by commercial agreement for allowing direct integration of remittance transaction with Fulfillment/Encashment Center and Remittance Platform 20.

Remittance platform 20 may also implement a card personalization feature. The card personalization feature is a required integration to the receiving Bank 32 card management system as the card Issuer to initiate the card personalization process of virtual card via Fulfillment/Encashment Center Office 38a.

A settlement process is important to complement the remittance system 10 for completion and settlement of the remittance process. The settlement process may be based on the agreed commercial settlement with a remittance partner 18, sender bank 16, fulfillment/encashment Center 38a, remittance platform 20 and receiving bank 32.

In case the sender remittance and the receiver's encashment are in different currencies, a foreign exchange (forex) feature may be required. Such currency rates conversion is normally computed at the destination PAN Card Management System (CMS) based on their prevailing FOREX rate conversion.

ATM Withdrawal 38b is a terminal providing the beneficiary to immediately withdraw the remittance amount via ATM if PAN and physical card linked to beneficiary mobile number is available for ATM withdrawals. This can be substituted by open-the counter transaction to the receiving bank.

The embodiment with reference to FIG. 1 will be described in the context of a sender 12 making a remittance request to be sent to a beneficiary 40. It is to be appreciated that beneficiary 40 has a mobile identification number such as the MSISDN.

The sender 12 goes to the bank 16 for a remittance transaction using his/her primary account number (PAN) issued by card issuer and linked to a fund source. The sender then specifies the target mobile identification number (MIN) and other information relating to the beneficiary 40.

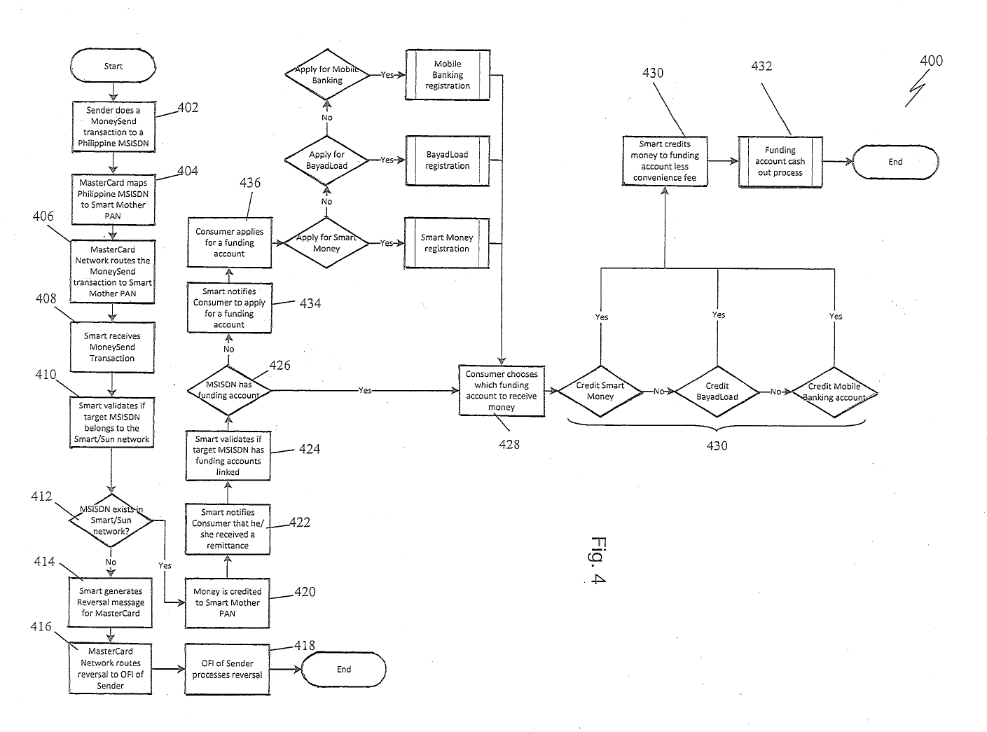

The sender bank Card Management Centre (CMS) authorizes the remittance transaction and then send the target remittance request 14 either directly to Acquiring Gateway 22 (based on available direct integration) or via a remittance protocol of Payment Brand network (e.g. ‘MoneySend’ process described in FIG. 4) or Visa® Money Transfer.

The acquiring Gateway 22 receives and validates the remittance request and then route the transaction request 14 to the remittance platform 20 based on transaction type.

The remittance platform 20 further validates the remittance transaction request 14 and check the specified beneficiary MIN against the customer profile database 26 if the MIN is already linked with an approved PAN for purpose of completing the remittance.

Once it is determined that the beneficiary MIN is already linked with an approved PAN, the remittance platform 20 will route the remittance request 14 to the receiving card host 32 Content Management System (CMS) based on the issuer of beneficiary PAN linked to MIN with the authorized remittance credit. The receiving card host 32 checks if the linkage is properly made and valid, and replies back to Remittance Platform 20 on the status (i.e. successful or unsuccessful).

Upon determining that the status is successful, the remittance platform 20 sends a notification to Sender (MIN or Email Address based on available data element in the transaction request) and Beneficiary MIN.

Both Sender 12 and Beneficiary 40 will receive the remittance transaction notification in the following forms:—

a. The sender 12 will receive the successful remittance notification with reference number through SMS or Email Address based on available data element in the transaction request; and
b. The beneficiary 40 will receive the successful remittance with reference number.

The beneficiary 40 may encash the remittance amount either

i. via Fulfillment/Encashment center 38a if his PAN linked to MIN has no physical card yet
ii. via ATM 38b if his PAN has physical card and allowed ATM transaction
iii. via Receiving Bank Over-the-Counter 38c remittance transaction with/without physical card.

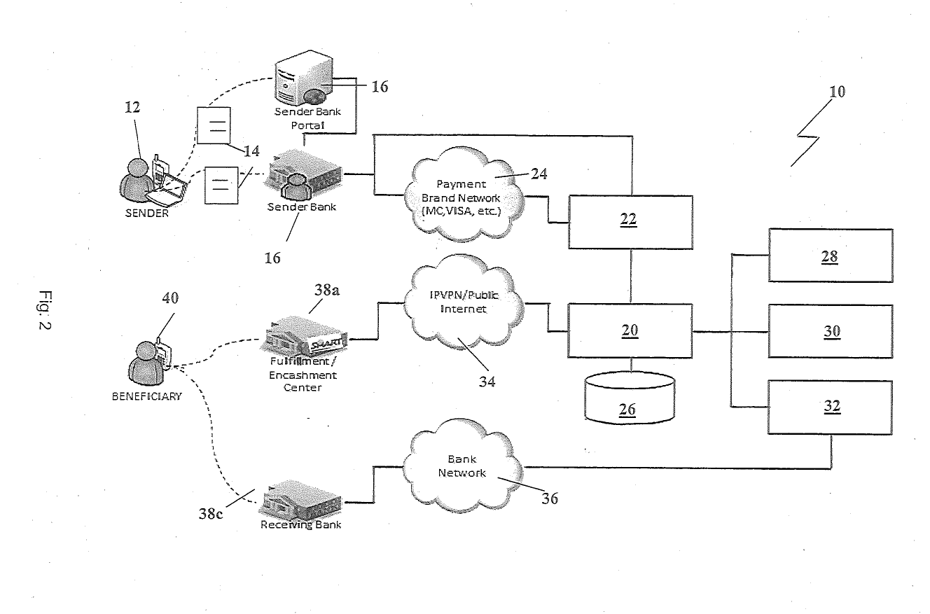

In accordance with another embodiment of the invention and with reference to FIG. 2 where like numerals reference like parts, there comprises a case scenario where the Sender 12 send through the Sender Bank Over-the-Counter or Portal remittance channel 16 using his/her primary account number (PAN) for remittance transaction to a beneficiary 40 using the mobile identification number (MIN) for identification, in the specific case where the beneficiary 40 does not have a PAN.

Sender 12 goes to Sender Bank Over-the-counter channel 16 for remittance request 14 using his/her PAN as fund source and specifies the target MIN and Beneficiary information.

Sender bank Card Management Centre authorizes the remittance request 14 then send the target remittance request 14 either directly to Acquiring gateway (GW) 22 based on available direct integration or via remittance protocol of Payment Brand network (e.g. MoneySend, Visa Money Transfer) 24.

Acquiring Gateway 22 receives and validates the transaction request 14 and then route the transaction request 14 to the remittance platform 20 based on transaction type.

The remittance platform 20 will validate and note that the specified beneficiary MIN has no link to an account or PAN. In such a case, the remittance platform 20 will invoke the dispense process to record inventory for available virtual PAN as default issuer and receiving bank. The remittance platform will invoke an auto-enrol process to generate a virtual PAN based on the MIN of the beneficiary and store the linking MIN and virtual PAN information.

The remittance platform 20 will route the remittance request 14 to the receiving card host 32 Content Management System (CMS) based on the issuer of beneficiary PAN linked to MIN with the authorized remittance credit. The receiving card host 32 checks if the linkage is properly made and valid, and replies back to Remittance Platform 20 on the status (i.e. successful or unsuccessful).

Remittance Platform 20 then sends the notification to Sender (MIN or Email Address based on available data element in the transaction request) and the Beneficiary MIN

Both Sender 12 and Beneficiary 40 may receive the transaction notifications in one or both of the following form:—

a. Sender 12 will receive the successful transaction with reference number thru SMS 30 or Email Address 28 based on available data element in the transaction request.
b. Beneficiary will receive the successful transaction thru SMS with reference number and advice message to visit nearest Fulfilment/Encashment Centre 38a or Receiving bank branch 38c to en-cash their money using the reference number and/or apply to personalized their virtual PAN. The option of ATM is not available to the beneficiary 40 as he/she does not have a physical card yet.

The beneficiary 40 may en-cash the remittance amount and/or personalize virtual PAN either:

i. via the Fulfilment/Encashment centre 38a if his PAN linked to MIN has no physical card yet; or
ii. via the Receiving Bank Over-the-Counter 38c remittance transaction.

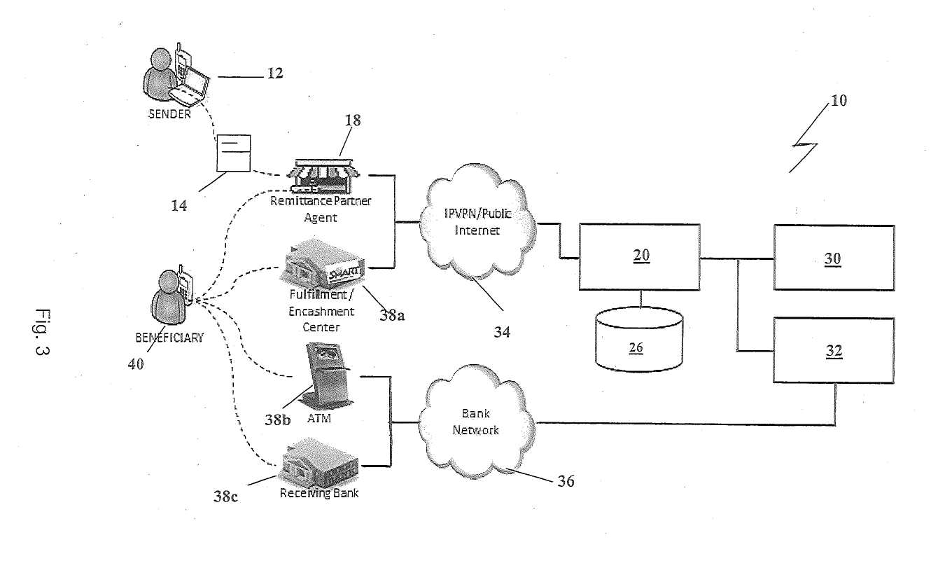

In accordance with another embodiment of the invention and with reference to FIG. 3 where like numerals reference like parts there is a scenario where the sender 12 does not have any account with any financial institutions, such as banks, for performing remittance. This embodiment is particularly suitable for overseas workers, who may not have a bank account in the resident countries they are in. The transaction request 14 through remittance is done via an authorized partner agent 18, where the Sender is un-bank and the cash remittance transaction will be sent to a beneficiary 40 account linked to the beneficiary's MIN.

The Sender 12 goes a nearest Remittance Partner Agent 18 branch for generating the remittance request 14. He specifies the Beneficiary MIN and other Know Your Customer (KYC) related information.

The Remittance Partner Agent 18 will receive the monies to be remitted (cash) from Sender 12 and then send the online remittance request 14 using Remittance Agent PAN as fund source to beneficiary MIN as a target pseudo PAN.

The Remittance Platform 20 will validate the remittance request 14 and check the specified beneficiary MIN against customer profile database 26 if the specified beneficiary MIN has no link of account or PAN. Upon successful validation, the remittance platform 20 will

a. invoke the dispense process to record inventory for available Virtual PAN of the same issuer bank of Remittance Partner Agent PAN for linkage with the beneficiary MIN; and
b. invoke the auto-enrol process to store the linking MIN and virtual PAN information.

The remittance platform 20 will perform the PAN to PAN fund transfer to Card Management Centre 32 receiving bank (also the Issuer Remittance Partner Agent PAN). The receiving bank 32 then authorizes a fund transfer and reply back to Remittance Platform 20.

Upon successful fund transfer, the Remittance Platform 20 sends the successful response back to Remittance Partner Agent 18.

The beneficiary 40 will receive the successful transaction notification with reference number via SMS.

The beneficiary 40 may encash the remittance amount either

a. via Fulfilment/Encashment centre 38a if his PAN linked to MIN has no physical card yet;
b. via ATM 38b if his PAN has physical card and allowed ATM transaction; or
c. via Receiving Bank Over-the-Counter remittance transaction 38c with/without physical card.

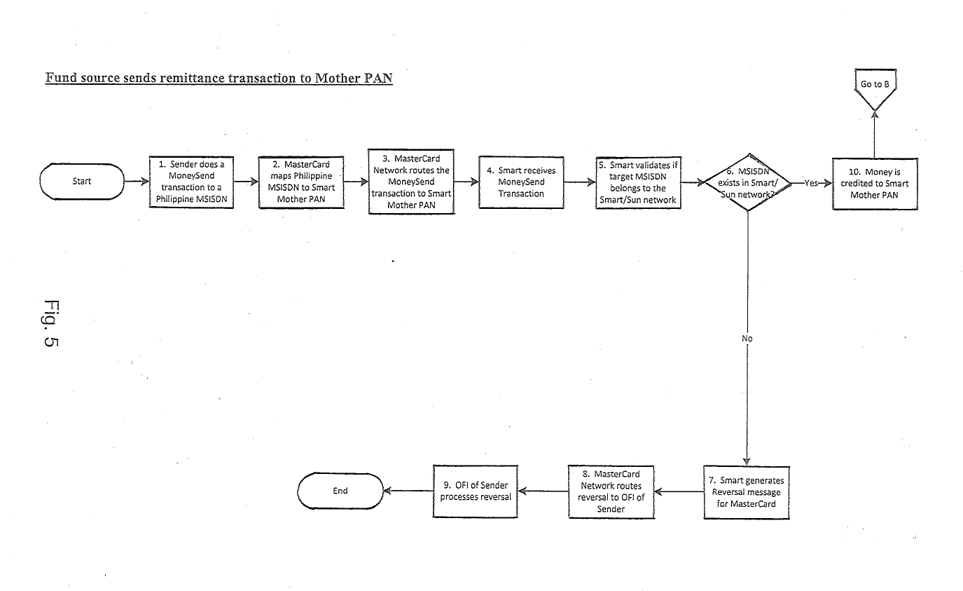

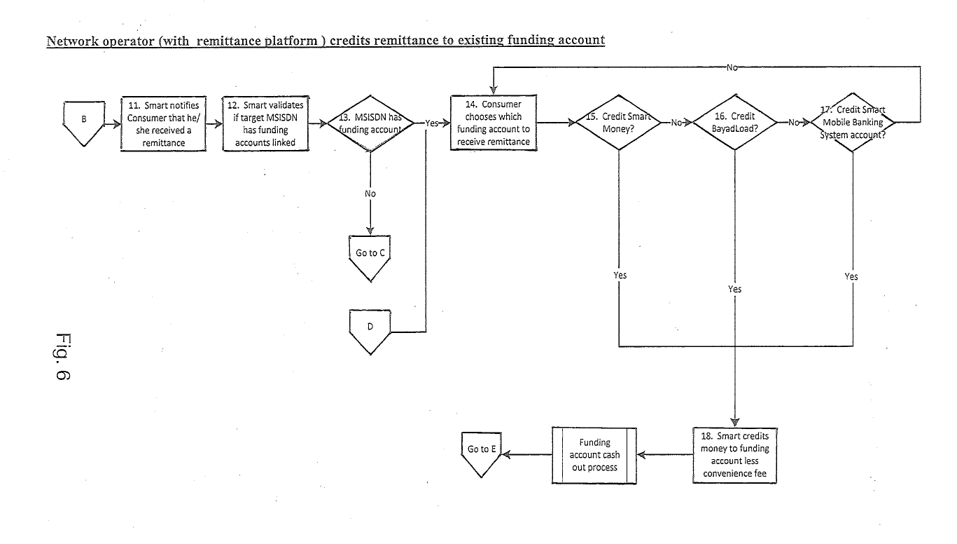

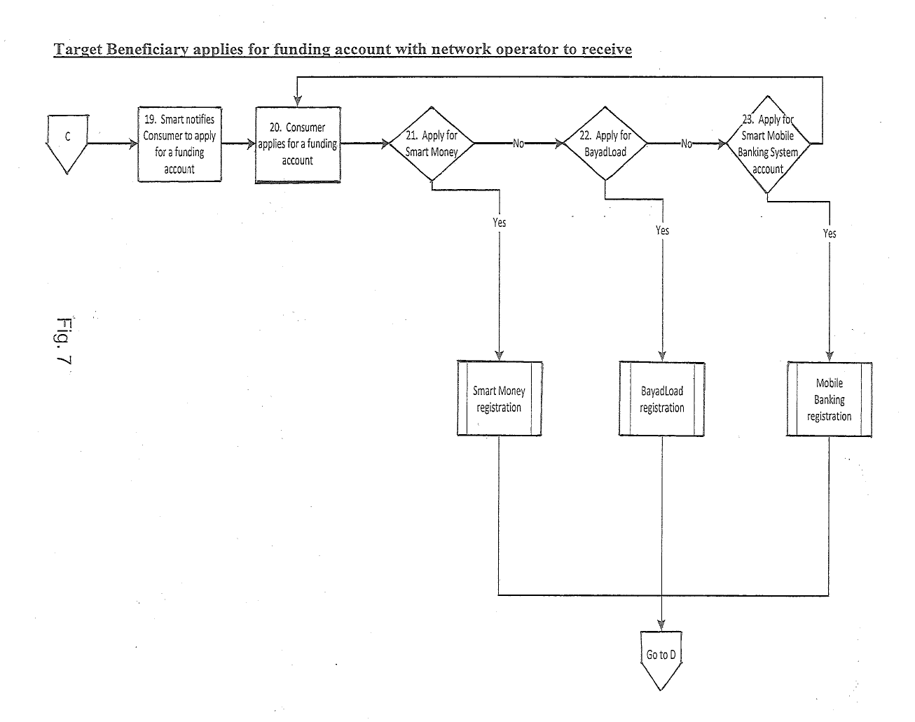

With regards to the remittance process as mentioned in the various embodiments, an overview is provided as shown in FIG. 4 to FIG. 8. In particular, for any remittance sent to a beneficiary account identified by a mobile identification number (MIN) such as the MSISDN, there exists a temporary holding account (known as a ‘Mother PAN’) that will receive the remittance. The remittance platform 20 will notify the beneficiary 40 that it has received a remittance. The beneficiary 40 may choose their preferred account where the remittance will be credited to. Once the beneficiary 40 has chosen the preferred account, remittance platform 20 will transfer money from the “Mother PAN” holding account to the Consumer account.

As a proposed revenue model, the target beneficiary 40 may be charged a ‘convenience fee’ when the money has been credited to the preferred account.

FIG. 4 provides an overview of the remittance process in the context where the sender 12 or remittance agent 18 is a subscriber to a network operator hosting the remittance system 10 and has an account with a fund source (i.e. the sender 12 and remittance agent 18 both have a PAN for initiating remittance). The network operator is arranged in data communication with the fund source. The fund source is typically a financial institution such as, but not limited to Mastercard®, Western Union™ etc. The network operator has a ‘Mother PAN’ assigned by the fund source which is used to transact with the fund source. It is to be appreciated that the fund source has modified its remittance service to accept an identifier (such as MSISDNs) of the beneficiary target, instead of a PAN. To utilize the Mother PAN, the network operator would have to create an account in the content management system (CMS).

The process 400 begins with the sender 12 sending a remittance request to a target beneficiary 40 within the network coverage of the network operator via an identifier, such as the MSISDN of a mobile device of the target beneficiary (step 402). The target beneficiary 40 does not have a PAN and as such the fund source maps the MSISDN to the Mother PAN of the network operator (step 404). The fund source then routes the request to the Mother PAN account of the network operator. The routing would include the generation of an ISO message comprising a unique transaction reference by the fund source and the target MSISDN information will be included (step 406). Upon receipt of the transaction request (step 408), the network operator validates if the MSISDN of the target beneficiary belongs to its network or extended network (step 410) and different services or databases may be utilized within the network operator to determine the same (step 412). If the MSISDN of the target beneficiary 40 is not within the network, then a reverse transaction is generated by the network operator to the fund source, the fund source then routes the transaction reversal and informs the sender 12 (step 414 to 418). If the MSISDN of the target beneficiary 40 belongs to the network, then the funds are credited to the Mother PAN account (step 420), and an ISO response will be generated by the CMS to the fund source. Next, the network operator notifies the target beneficiary 40 that he/she has received a remittance (step 422). The notification may be sent via SMS or any other known communications protocol as desired. Information within the notification may include the amount received, transaction reference number, any convenience fee to be applied etc.

The network operator may proceed to validate or determine if the target beneficiary 40 has any funding account linked to the MSISDN via any electronic wallet/mobile banking accounts provided/authorized/partnered by the network operator in conjunction with the fund source (step 424). If the MSISDN is tied to a plurality of funding accounts (step 426), the target beneficiary 40 is given the option to determine the funding account to receive the remittance (step 428) and if there is only one funding account, then the remittance will automatically be credited to the single funding account. It is to be appreciated that a facility would prompt the beneficiary 40 on which account he/she wishes to choose for the deposit of the remittance monies. Should the remittance not be credited or selected within a predetermined time frame, such as within 7 days, the remittance will be reversed.

Any convenience fee or middleman fee payable to the network operator would be deducted before the remittance is credited to the funding account (step 430). Depending on the arrangement with the network operator, such convenience fee varies depending on the funding account selected, and may be waived if it is a funding account linked to an electronic wallet provided by the network operator. The target beneficiary may then encash the remittance sum (step 432).

If there is no funding account based on step 426, the network operator then notifies the target beneficiary 40 to apply for a funding account (step 434). There is a time frame given to the target beneficiary 40 to apply for the funding account, and if lapsed, the remittance process will be reversed.

Once the target beneficiary 40 applies for the funding account (step 436), he will need to go through the necessary registration and ‘Know your customer’ personalization where necessary. Certain funding accounts may also allow for enhanced case-out facilities (step 438). Once registered, steps 428, 430 and 432 are then followed to complete the deposit of remittance monies into the selected funding account.

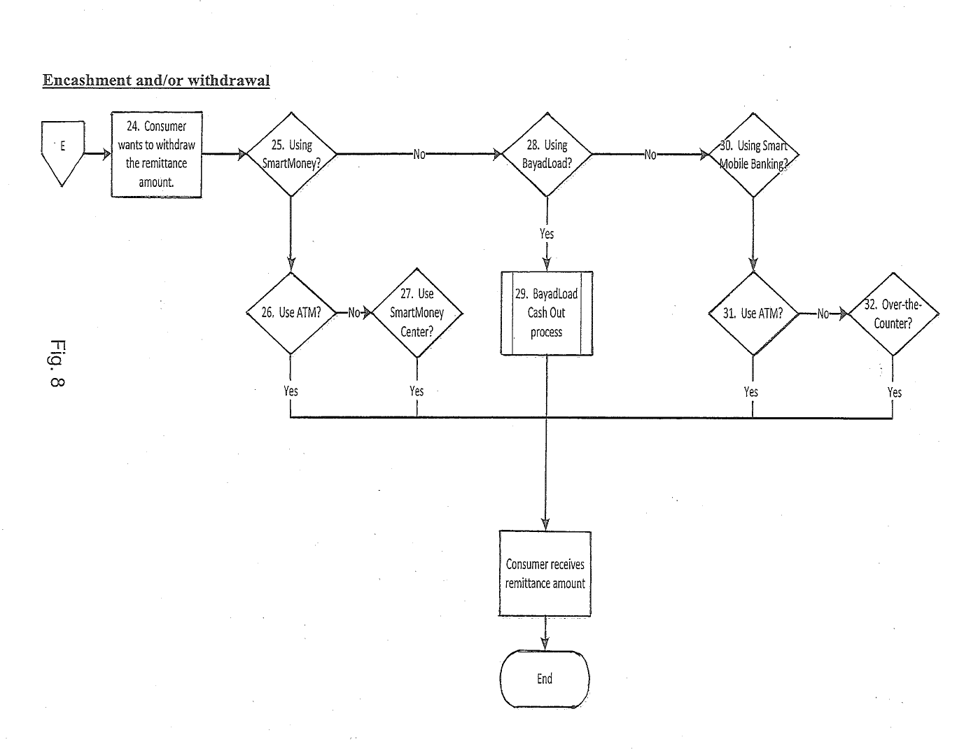

The process of encashment following step 432 is illustrated in FIG. 8. In particular, depending on the funding account and electronic wallet combinations, the target beneficiary may encash the remittance monies via ATM (withdrawal fees apply), specialized remittance centres (cash-out fees may apply), or over the counter (bank withdrawal fees may apply).

In accordance with another embodiment of the invention, wherein like reference numerals reference like parts, the remittance system 10 comprises an additional feature such that the destination mobile number (MIN) of the sender 12 or beneficiary 40 may be linked to the email address or other “destination accounts” such as an email, an electronic wallet account, and/or social media accounts linked to the mobile number.

The linkage such that the destination MIN of the sender 12 or beneficiary 40 may be linked to the email address or other destination accounts is an extension of the aforementioned embodiments of transferring funds/remittance by allowing a sender 12 to transfer to a beneficiary 40 account linked or tied to an email account and/or a host of the popular social media sites, without being restricted to the MIN of the sender or beneficiary. A common electronic wallet account linking the various social networks, email accounts of the particular user (sender or beneficiary) will be needed to consummate the transaction between mobile to social account/s.

For purposes of an account creation, consumers (i.e. sender or beneficiary) may use their social media or email account as their Login/User ID. The process associated with the use of additional destination accounts is outlined as follows:—

Step 1: Registration. The first step in this process is to register the consumer's mobile number (MIN) and through the service provider's (i.e. network operator) mobile platform, link his funding account/s to his phone. He will also be issued a Mobile personal identification number (PIN).

Once registered, the registered user will have the option to use the social media or email account USERID to login to his electronic wallet account.

Step 2: Wallet Account Creation. Upon registration, the platform will generate and assign a particular electronic wallet for the account for the consumer. The electronic wallet account is created linking the fund sources and various identifications. This will be a backend process since the consumer only has to use his mobile phone number as the account to transact.
Step 3: Activation. There will be a one-time validation to ensure the mobile phone number and the source account are all linked accurately through an OTP (one-time-pin/password) to validate.
Step 4: Usage. Once activated, the customer can start using his electronic wallet account registered against his mobile phone.

In terms of operation, a sender having the electronic wallet just needs to perform the remittance transfer by choosing a destination account and “charging it to his mobile phone” along with his mobile PIN. A notification message will also be sent to the mobile phone of the beneficiary.

In addition to the above described possible linkage between social media accounts, mobile phone numbers etc, it is to be appreciated that additional “destination accounts” may be linked as part of the process to create an electronic wallet account.

The embodiment with additional linkage to social media, email accounts etc. provides a convenient way to transfer/send or pay among people/subscribers since the mobile phone is the most pervasive device by almost everyone.
Introduce a differentiated transfer/payment experience through the mobile phone, paperless, and utilize existing digital/social media available to the most “connected” people
Bridging the gap by integrating financial, mobile and social media processes and find a common access point for people to transact and carry out the basic financial transactions
Utilizing the various embodiments of the invention, customers can perform different ways of transferring/paying/sending money aside from the traditional payment channels available currently. This allows greater convenience, speed and adoption of seamless, mobile technologies to be experienced by the subscribers.

It is to be appreciated that the linking to a common mobile wallet to various accounts and/or identifier as described enables the sender and a target beneficiary within matching funding account to receive remittance facilitated by a network operator. Linking may be performed by the network operator in conjunction with the fund source and creation of electronic wallets.

By providing the remittance facility 10 to perform varied mobile transfers, customers/subscribers (both sender 12 and target beneficiary 40) will enjoy the following features of the service:—
Secure transaction through a masking of the real fund source account by the mobile number (MIN). The remittance system 10 is advantageous in that it provides a seamless transaction between sender and beneficiary through the use of mobile devices to facilitate the transaction.
The remittance system 10 provides a convenient way of peer-to-peer transfer and communication.
Compared to the prior art remittance centres, the described embodiments are paperless.
Integrated mobile wallet across channels
All mobile enabled or social media enabled
Quick and fast transactions
Lower fees
Use of Mobile as enabler for payment linked to any account for transfers and payments
Simpler than common Mobile Banking Platforms
Destination Accounts are various with better coverage across media
The social media or email account can be used as a Login/User ID

The invention is set to provide the mobile version of vs. traditional money transfer in the market. This is backed by a fully mobile/electronic architecture from start to end. It frees the consumers from undergoing the traditional long queues or paper method or even the semi-electronic way through portals.

In various embodiments as described a Money Transfer Control Number (MTCN) may be generated as part of the remittance transaction. The MTCN may be provided to the target beneficiary 40. In particular, upon receiving a confirmation message that monies have been remitted, a notification (in the form of an SMS or other means) may be sent to the recipient's MSISDN (MIN).

The notification may comprise the following information:—

i. Sender's full name (the first, middle and last names as signed on the ‘To Send Money’ form);
ii. City and Country where the money was remitted;
iii. Amount of remittance; and
iv. Money Transfer Control Number (MTCN)

In the embodiments involving a Remittance Partner Agent 18, when the target beneficiary 40 visits a remittance agent 18 for encashment, the notification with the MTCN may be shown together with a valid photo identification (original copy). The generated notification may comprise the following information

Money Transfer Control Number (MTCN); Sender's full name; City and Country where the money was sent from; and the expected Amount of the money transfer. Once verified, the target beneficiary reviews and sign a receipt before receiving the money. The remittance agent 18 will then hand the money together with the receipt. This completes the remittance transaction.

Although the afore-described embodiments are described based on remittance transactions between various parties, it is to be appreciated that the remittance system 10 may be adapted for other types of transactions requiring the target beneficiary 40 PAN to be linked or matched to the sender 12 PAN.

It should be further appreciated by the person skilled in the art that variations and combinations of features described above, not being alternatives or substitutes, may be combined to form yet further embodiments falling within the intended scope of the invention.

1. A remittance system comprising
a remittance platform operable to process a remittance request originating from a sender to a target beneficiary; the remittance request comprising a primary account number (PAN) of the sender;
the remittance platform further operable to create an electronic account for the target beneficiary upon determining that the target beneficiary does not have an approved PAN for remittance to take place;
wherein the creation of the electronic account comprises a link between a unique identifier of the target beneficiary and the generation of a primary account number (PAN) for the beneficiary.

2. The remittance system according to claim 1, wherein the unique identifier is one of the following: a mobile identifier of the target beneficiary, a social network account for the target beneficiary.

3. The remittance system according to claim 1, wherein the PAN of the sender is linked to a fund source.

4. The remittance system according to claim 3, wherein the fund source is a bank, a credit card company, or other financial institutions.

5. The remittance system of claim 3, wherein the beneficiary PAN is generated to match the PAN of the sender.

6. The remittance system according to claim 1, wherein the electronic account comprises an electronic wallet.

7. The remittance system according to claim 6, wherein the electronic wallet is linked to a plurality of identifiers of the sender or beneficiary.

8. The remittance system according to claim 7, wherein the plurality of identifiers include email address; social network accounts; and mobile identification number.

9. The remittance system according to claim 1, wherein the remittance platform is in data communication with a customer profile database.

10. The remittance system according to claim 1, wherein if the sender is not linked to a fund source, the primary account number of the sender is provided by an authorized remittance agent.

11. A method of remittance from a sender to a target beneficiary comprising
receiving a remittance request originating from the sender; the remittance request comprising a primary account number (PAN) of the sender;
determining whether the target beneficiary has a approved PAN for remittance to take place; and
creating an electronic account for the target beneficiary if there is no approved PAN;
wherein the creation of the electronic account comprises a link between a unique identifier of the target beneficiary and the generation of a primary account number for the beneficiary.

12. The method of remittance according to claim 11, wherein the unique identifier is one of the following: a mobile identifier of the target beneficiary, a social network account of the target beneficiary.

13. The method of remittance according to claim 11, wherein the PAN of the sender is linked to a fund source.

14. The method of remittance according to claim 13, wherein the fund source is a bank, a credit card company, or other financial institutions.

15. The method of remittance according to claim 13, wherein the beneficiary PAN is generated to match the PAN of the sender.

16. The method of remittance according to claim 11, wherein the electronic account comprises an electronic wallet.

17. The method of remittance according to claim 16, wherein the electronic wallet is linked to a plurality of identifiers of the sender or beneficiary.

18. The method of remittance according to claim 17, wherein the plurality of identifiers include email address; social network accounts; and mobile identification number.

19. The method according to claim 1, wherein if the sender is not linked to a fund source, the primary account number of the sender is provided by an authorized remittance agent.
